(19) United States
(12) Patent Application Publication
(10) Pub. No.: US 2026/0213450 A1
(43) Pub. Date: Jul. 23, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: FANG-JWU LIAO, New Taipei (TW); JIA-HAU LIU, New Taipei (TW); CHI-HSIANG LU, New Taipei (TW)

(21) Appl. No.: 19/457,064

(22) Filed: Jan. 22, 2026

(30) Foreign Application Priority Data
Jan. 23, 2025 (CN) 202510106298.2

(51) Int. Cl. H01R 13/28; H01R 12/71; H01R 13/24; H01R 13/428; H01R 13/50

(52) U.S. Cl. CPC H01R 13/28; H01R 13/2442; H01R 13/428; H01R 13/50; H01R 12/714

(57) ABSTRACT

An electrical connector includes an insulating body, and at least one terminal fixed to the insulating body and having a first conductive member and a second conductive member. The first conductive member has a first connecting portion, a first resilient arm portion, and a first fixing portion. The first resilient arm portion and the first fixing portion are respectively connected to two ends of the first connecting portion. The second conductive member has a second connecting portion, a second resilient arm portion, and a second fixing portion. The second resilient arm portion and the second fixing portion are respectively connected to two ends of the second connecting portion. A width of the first connecting portion is smaller than a width of the first fixing portion. A width of the second connecting portion is smaller than a width of the second fixing portion.

### BACKGROUND OF THE INVENTION

### Field of the Invention

The present invention relates to an electrical connector, particularly to an electrical connector having a terminal accommodated in an insulating body.

### Description of Related Arts

Currently, contact connectors are typically required to establish electrical connections between different electronic modules, such as chip modules and circuit boards. In related technologies, the connector has an insulating body and terminals. The terminals are housed in the insulating body and have an arc-shaped structure having a first arm and a second arm, which protrude from two ends of the insulating body. When using the connector, the first and second arms resiliently press against the chip module and circuit board, respectively. However, the connectors described above suffer from the technical problem of inefficient space utilization.

### SUMMARY OF THE INVENTION

An electrical connector includes an insulating body, and at least one terminal fixed to the insulating body and having a first conductive member and a second conductive member independent of each other. The first conductive member has a first connecting portion, a first resilient arm portion, and a first fixing portion. The first resilient arm portion and the first fixing portion are respectively connected to two ends of the first connecting portion. The second conductive member has a second connecting portion, a second resilient arm portion, and a second fixing portion. The second resilient arm portion and the second fixing portion are respectively connected to two ends of the second connecting portion. A width of the first connecting portion is smaller than a width of the first fixing portion and is offset to form a first accommodating space below the first fixing portion. A width of the second connecting portion is smaller than a width of the second fixing portion and is offset to form a second accommodating space above the second fixing portion. The first connecting portion is positioned in the second accommodating space, and the second connecting portion is positioned in the first accommodating space.

### BRIEF DESCRIPTION OF DRAWINGS

FIG. 1 shows a perspective view of an electrical connector according to some embodiments of the present disclosure;

FIG. 2 shows an exploded view of the electrical connector according to some embodiments of the present disclosure;

FIG. 3 shows a schematic diagram of a terminal abutting two electronic modules according to some embodiments of the present disclosure;

FIG. 4 shows a perspective view of a terminal having a first conductive member and a second conductive member in a natural state according to some embodiments of the present disclosure;

FIG. 5 shows a perspective view of the terminal having the first conductive member and the second conductive member in a compressed state according to some embodiments of the present disclosure;

FIG. 6 shows an exploded view of the terminal having the first conductive member and the second conductive member; and

FIG. 7 shows a cutaway view of an electrical connector according to some embodiments of the present disclosure.

### DETAILED DESCRIPTION OF THE DRAWINGS

In the description of the embodiments of the present disclosure, the technical terms “first”, “second”, etc. are only used to distinguish different objects, and do not indicate or imply the relative importance or implicitly indicate the quantity, specific order or primary and secondary relationship of the indicated technical features. “Plural” means two or more, unless otherwise clearly and specifically limited.

In the present disclosure, unless otherwise explicitly stipulated and limited, the terms “connection”, “arranging”, “fixing” and other terms should be understood in a broad sense, such as a fixed connection, a detachable connection, or an integral connection; a direct connection, or an indirect connection through an intermediate medium, or a fluid communication between two elements. For those of ordinary skill in the art, the specific meanings of the above terms in the present disclosure can be understood according to specific circumstances.

Unless otherwise defined, all technical and scientific terms used herein have the same meaning as commonly understood by one of ordinary skill in the technical field to which the present disclosure belongs. The terminology used herein in the description of the present disclosure is for the purpose of describing specific embodiments only and is not intended to limit the application. The terms “comprising” and “having” and any variations thereof in the description and claims of the present disclosure and the above description of the drawings are intended to cover non-exclusively.

Reference herein to “an embodiment” means that a particular feature, structure or characteristic described in connection with the embodiment can be included in at least one embodiment of the present disclosure. The appearances of this phrase in various places in the specification are not necessarily all referring to the same embodiment, nor are separate or alternative embodiments mutually exclusive of other embodiments. Those skilled in the art understand, both explicitly and implicitly, that the embodiments described herein may be combined with other embodiments.

The present disclosure provides a terminal, which can be applied to an electrical connector.

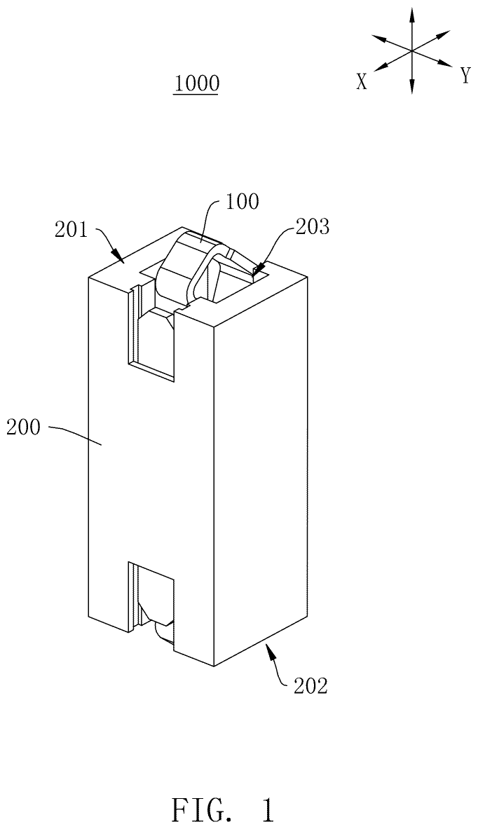

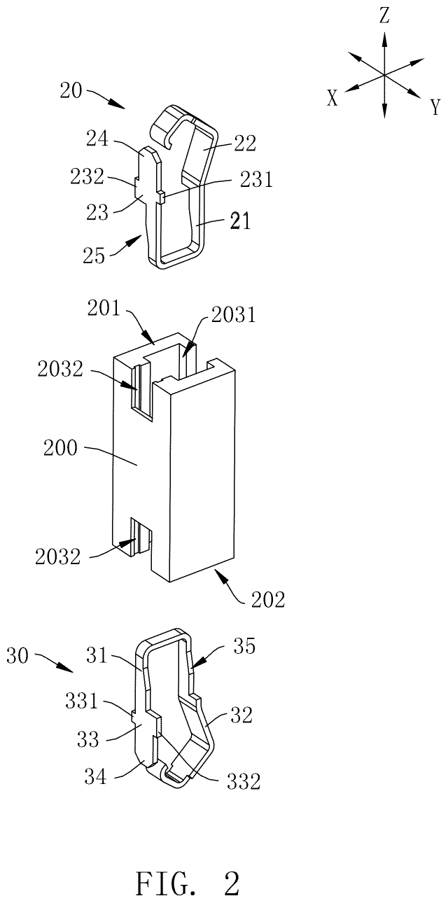

Referring to FIGS. 1 and 2, an electrical connector 1000 is used to electrically connect two electronic modules, for example, to electrically connect a chip module 2000 to a circuit board 3000. The electrical connector 1000 includes a terminal 100 and an insulating body 200. The insulating body 200 has a first face 201, a second face 202 and a terminal slot 203. The terminal slot 203 passes through the first face 201 and the second face 202. The terminal 100 is arranged in the terminal slot 203. The terminal slot 203 includes an accommodating slot 2031 and a fixing groove 2032. The accommodating slot 2031 and the fixing groove 2032 are connected to each other. Understandably, in the present embodiment, only one of terminal 100 for transmitting signals and the terminal slot 203 for accommodating said terminal 100 of the electrical connector 1000 is schematically shown. For example, in a chip connector, a plurality of terminals 100 can be provided in an array arrangement. Correspondingly, a plurality of terminal slots 203 can also be provided, which is not limited by the present disclosure.

The terminal 100 can have a plurality of metal plates that are each integrally stamped and bent. The terminal 100 has a first resilient arm portion 22 and a second resilient arm portion 32. The first resilient arm portion 22 is exposed at the first face 201 of the insulating body 200 to form an upper contact portion. The second resilient arm portion 32 is exposed at the second face 202 of the insulating body 200 to form a lower contact portion. When the electrical connector 1000 is located between two electronic modules, one of the electronic modules presses the first resilient arm portion 22, and the other electronic module presses the second elastic arm portion 32, so that the two electronic modules are electrically connected.

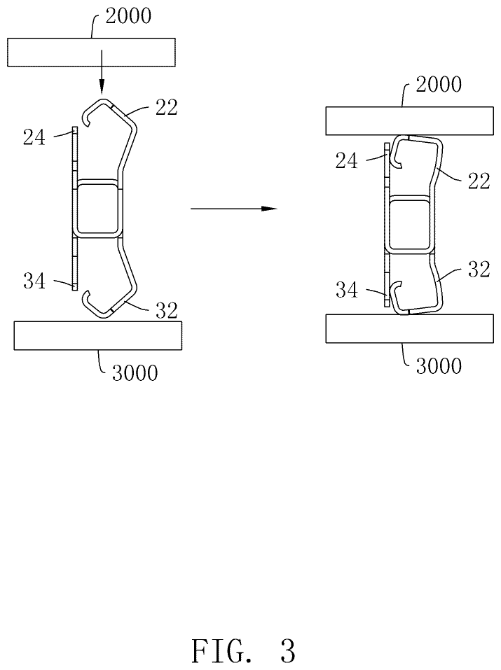

Referring to FIG. 3, for example, during use, the electrical connector 1000 is positioned between the chip module 2000 and the circuit board 3000. The chip module 2000 moves downward to press the first resilient arm portion 22 from above, and the circuit board 3000 presses the second elastic arm portion 32 from below, so that the first resilient arm portion 22 and the second resilient arm portion 32 are deformed, and the chip module 2000 and the circuit board 3000 are electrically connected. The pressing direction is represented by the Z-axis direction in the illustration as an example. It can be understood that the orientation descriptions in the present disclosure, such as up, down, etc., are based on the orientation of the product in actual application. If the orientation of the product changes, the corresponding orientation may also change, and is not limited by the present disclosure.

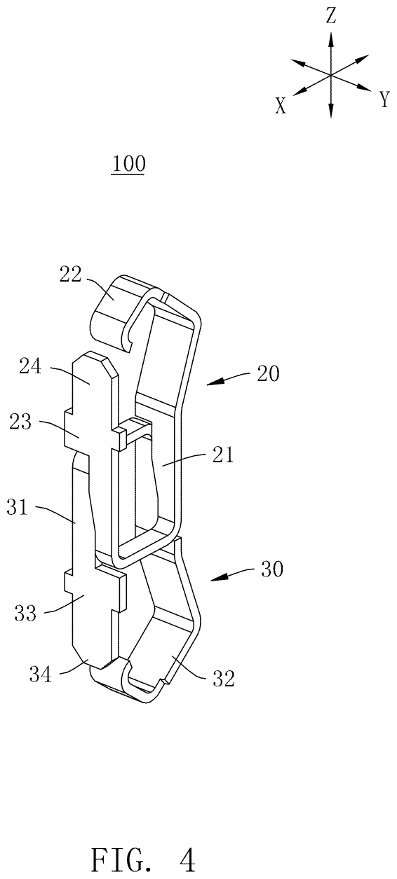

Referring to FIG. 4, in the present embodiment, the terminal 100 includes two independent conductive members 10. Each conductive member 10 can be integrally formed by punching and bending a metal plate. The two conductive members 10 are the first conductive member 20 and the second conductive member 30. The first conductive member 20 has a first connecting portion 21, a first resilient arm portion 22, a first fixing portion 23, and a first extending portion 24. The first resilient arm portion 22 and the first fixing portion 23 are respectively connected to two ends of the first connecting portion 21. The first resilient arm portion 22 is bent in a direction toward the first extending portion 23, and the end of the first resilient arm portion 22 is spaced apart from the first extending portion 24.

The second conductive member 30 has a second connecting portion 31, a second resilient arm portion 32, a second fixing portion 33, and a second extending portion 34. The second resilient arm portion 32 and the second fixing portion 33 are respectively connected to two ends of the second connecting portion 31. The second resilient arm portion 32 is bent in a direction toward the second extending portion 34, and the end of the second resilient arm portion 32 is spaced apart from the second extending portion 34.

The first conductive member 20 is inserted into the upper face of the insulating body 200. The first fixing portion 23 is inserted and fixed in the fixing groove 2032 through physical interference. The first connecting portion 21 and the first resilient arm portion 22 are inserted into the accommodating slot 2031. Similarly, the second conductive member 30 is inserted into the lower face of the insulating body 200. The second fixing portion 33 is inserted and fixed in the fixing groove 2032 through physical interference. The second connecting portion 31 and the second resilient arm portion 32 are inserted into the accommodating slot 2031. After the first conductive member 20 and the second conductive member 30 are inserted, the first connecting portion 20 and the second connecting portion 31 are arranged horizontally, and the first resilient arm portion 22 and the second resilient arm portion 32 are arranged vertically.

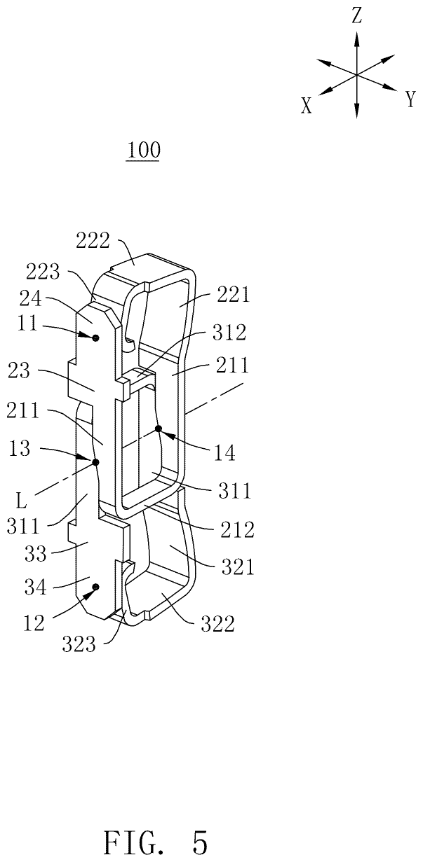

Referring to FIG. 5, when the terminal 100 is positioned between the two electronic modules, one electronic module presses against the first resilient arm portion 22, causing the end of the first resilient arm portion 22 to move towards and abut against the first extension portion 24; the other electronic module presses against the second resilient arm portion 32, causing the end of the second resilient arm portion 32 to move towards and abut against the second extension portion 34.

For example, the two electronic modules can be a chip module 2000 and a circuit board 3000. Furthermore, when the electronic modules press against the first resilient arm portion 22 and the second resilient arm portion 32, the first extension portion 24 can contact and support the first resilient arm 22 to ensure stable contact between the electronic module and the first resilient arm portion 22. At the same time, the second extension portion 34 can contact and support the second resilient arm portion 32 to ensure stable contact between the electronic module and the second resilient arm portion 32. The first connecting portion 21 abuts the second connecting portion 31 to ensure electrical connection between the first resilient arm portion 22, the second resilient arm portion 32, the first extension portion 24, and the second extension portion 34. In this way, the portions of the terminal 100 can be mutually supported and electrically connected through multiple contact points, thereby improving the contact stability and electrical connection stability between the terminal 100 and the electronic module.

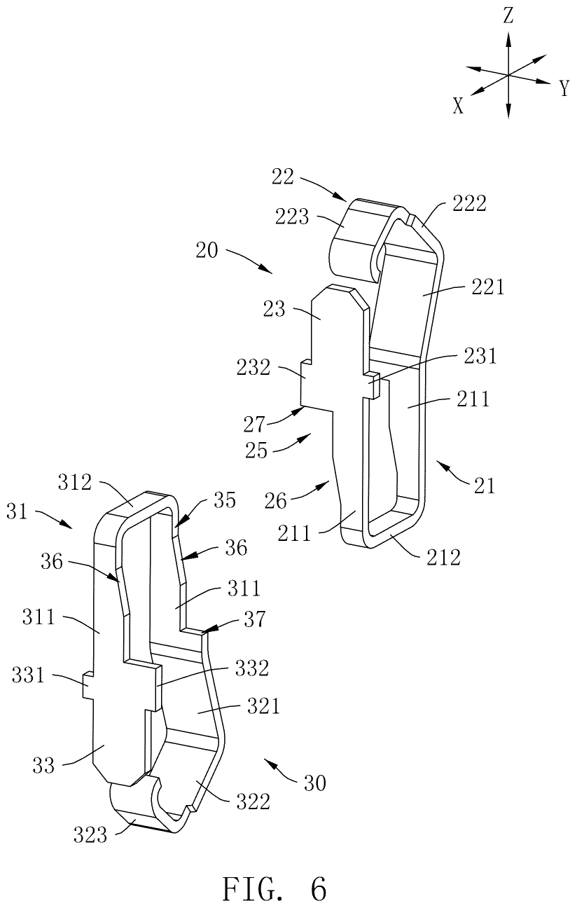

Referring to FIG. 6, in some embodiments, a width of the first connecting portion 21 is less than a width of the first fixing portion 23 and is offset, thus forming a first accommodating space 25 below the first fixing portion 23. A width of the second connecting portion 31 is less than a width of the second fixing portion 33 and is offset, thus forming a second accommodating space 35 above the second fixing portion 33. The first connecting portion 21 is positioned in the second accommodating space 35, and the second connecting portion 31 is positioned in the first accommodating space 25. The width directions of the first conductive member 20 and the second conductive member 30 are both represented by the Y-axis direction shown in the figure. It can be understood that the offset between two components in the above description refers to the fact that the projections of the two components in the corresponding directions have non-overlapping portions.

The first accommodating space 25 and the second accommodating space 35 can respectively accommodate the second connecting portion 31 and the first connecting portion 21, allowing the second connecting portion 31 and the first connecting portion 21 to be compactly arranged, reducing the occupied volume and improving space utilization.

In some embodiments, the first connecting portion 21 has a first inclined face 26 facing the first accommodating space 25, and the second connecting portion 31 has a second inclined face 36 facing the second accommodating space 35. The first inclined face 26 and the second inclined face 36 abut against each other. Understandably, when the first conductive member 20 and the second conductive member 30 are respectively pressed, the first inclined face 26 and the second inclined face 36 press against each other along a first direction, forming mutual support and electrical connection between the first connecting portion 21 and the second connecting portion 31, thereby improving contact stability and electrical connection stability. The first direction is parallel to the pressing direction of the electronic modules, for example the Z-axis direction in the figure.

In some embodiments, the first connecting portion 21 and the second connecting portion 31 are both U-shaped and include two vertical portions and a horizontal portion connecting the two vertical portions. One of the vertical portions of the first conductive member 20 has the first inclined face 26, and one of the vertical portions of the second conductive member 30 has the second inclined face 36.

For example, the first connecting portion 21 includes two first vertical portions 211 and a first horizontal portion 212 connecting the two first vertical portions 211. One of the first vertical portions 211 is connected to the first resilient arm portion 22, and the other first vertical portion 211 is connected to the first fixing portion 23.

The second connecting portion 31 includes two second vertical portions 311 and a second horizontal portion 312 connecting the two second vertical portions 311. One of the second vertical portions 311 is connected to the second resilient arm portion 32, and the other second vertical portion 311 is connected to the second fixing portion 33.

In the examples of the present disclosure, the first vertical portion 211 and the second vertical portion 311 are both parallel to the first direction, and the first horizontal portion 212 and the second horizontal portion 312 are both parallel to a second direction. The first and second directions are perpendicular to each other. The second direction is exemplified by the X-axis direction shown in the figures.

In some embodiments, a width of the first vertical portion 211 tapers towards the first horizontal portion 212 to form the first inclined face 26 on its face facing the first accommodating space 25. A width of the second vertical portion 311 tapers towards the second horizontal portion 312 to form a second inclined face 36 on its face facing the second accommodating space 35.

In some embodiments, the first resilient arm portion 22 includes sequentially a first outward-bending section 221, a first protruding section 222, and a first inward-bending section 223. The end of the first outward-bending section 221 away from the first protruding section 222 is connected to the first connecting portion 21, and the end of the first inward-bending section 223 away from the first protruding section 222 forms the end of the first conductive member 20. The first protruding section 222 is used for contacting the electronic module. The first inward-bending section 223 is used for contacting the first extension portion 24.

For example, one end of the first outward-bending section 221 is connected to the corresponding first vertical portion 211, and the first outward-bending section 221 is bent relative to the first connecting portion 21 in a direction away from the first extension portion 24. The first protruding section 222 is connected to the end of the first outward-bending section 221 away from the first vertical portion 211, and the first protruding section 222 is bent relative to the first outward-bending section 221 in a direction toward the first extension portion 24. The first inward-bending section 223 is connected to the end of the first protruding section 222 away from the first outward-bending section 221, and the first inward-bending section 223 bends relative to the first protruding section 222 towards the first extension portion 24.

It is worth noting that the above description only refers to the natural state of the first resilient arm portion 22. When the first resilient arm portion 22 is in a pressed state, it can undergo corresponding changes, and the present disclosure does not impose limitations herein. The natural state refers to the state in which the first resilient arm portion 22 is not deformed by the electronic module. The pressed state refers to the state in which the first resilient arm portion 22 is deformed by the electronic module.

Understandably, by the bending arrangement between the first outward-bending section 221 and the first vertical portion 211, the first resilient arm portion 22 can be bent overall towards the first extension portion 24, thereby increasing the deformation range of the first resilient arm portion 22 and facilitating its movement towards the first extension portion 24 after being pressed by the electronic module. Furthermore, the bending arrangement between the first outward-bending section 221 and the first protruding section 222 allows the first protruding section 222 to protrude along a first direction, facilitating contact between the first protruding section 222 and the electronic module. Additionally, the bending arrangement between the first protruding section 222 and the first inward-bending section 223 shortens the distance between the first inward-bending section 223 and the first extension portion 24, ensuring timely contact between the first resilient arm portion 22 and the first extension portion 24 after the first resilient arm portion 22 is pressed by the electronic module.

In some embodiments, the connection between the first outward-bending section 221 and the first protruding section 222 has a smooth, arc-shaped transition. The end of the first inward-bending section 223 away from the first protruding section 222 is curved towards the first outward-bending section 221, reducing wear and improving durability.

In some embodiments, the second resilient arm portion 32 includes sequentially a second outward-bending section 321, a second protruding section 322, and a second inward-bending section 323. The end of the second outward-bending section 321 away from the second protruding section 322 is connected to the second connecting portion 31, and the end of the second inward-bending section 323 away from the second protruding section 322 forms the end of the second conductive member 30. The second protruding section 322 is used for contacting the electronic module. The second inward-bending section 323 is used for contacting the second extension portion 34.

For example, one end of the second outward-bending section 321 is connected to the corresponding second vertical portion 311, and the second outward-bending section 321 is bent relative to the second connecting portion 31 in a direction away from the second extension portion 34. The second protruding section 322 is connected to the end of the second outward-bending section 321 away from the second vertical portion 311, and the second protruding section 322 is bent relative to the second outward-bending section 321 in a direction toward the second extension portion 34. The second inward-bending section 323 is connected to the end of the second protruding section 322 away from the second outward-bending section 321, and the second inward-bending section 323 bends relative to the second protruding section 322 towards the second extension portion 34.

It is worth noting that the above description only refers to the natural state of the second resilient arm portion 32. When the second resilient arm portion 32 is in a pressed state, it can undergo corresponding changes, and the present disclosure does not impose limitations herein. The natural state refers to the state in which the second resilient arm portion 32 is not deformed by the electronic module. The pressed state refers to the state in which the second resilient arm portion 32 is deformed by the electronic module.

Understandably, by the bending arrangement between the second outward-bending section 321 and the second vertical portion 311, the second resilient arm portion 32 can be bent overall towards the second extension portion 34, thereby increasing the deformation range of the second resilient arm portion 32 and facilitating its movement towards the second extension portion 34 after being pressed by the electronic module. Furthermore, the bending arrangement between the second outward-bending section 321 and the second protruding section 322 allows the second protruding section 322 to protrude along a first direction, facilitating contact between the second protruding section 322 and the electronic module. Additionally, the bending arrangement between the second protruding section 322 and the second inward-bending section 323 shortens the distance between the second inward-bending section 323 and the second extension portion 34, ensuring timely contact between the second resilient arm portion 32 and the second extension portion 34 after the second resilient arm portion 32 is pressed by the electronic module.

In some embodiments, the connection between the second outward-bending section 321 and the second protruding section 322 has a smooth, arc-shaped transition. The end of the second inward-bending section 323 away from the second protruding section 322 is curved towards the second outward-bending section 321, reducing wear and improving durability.

In some embodiments, the first extension portion 24 extends along the first direction and is formed by extending upward from the first fixing portion 23. The first fixing portion 23 connects to a first fixing section 212, and the first extension portion 24 provides contact for the first inward-bending section 223. The first fixing portion 23 and the first resilient arm portion 22 each has a downward-facing first stop face 27, located beside the first connecting portion 21. The second connecting portion 31 is blocked below the first stop face 27.

In some embodiments, the width of the first fixing portion 23 is greater than the width of the first extension portion 24, and the width of the first connecting portion 21 is less than the width of the first extension portion 24, so that the first fixing portion 23 can be inserted and fixed in the fixing groove 2032.

In some embodiments, the first fixing portion 23 includes a first protrusion 231 and a second protrusion 232 arranged on two sides thereon. A height of the first protrusion 231 is less than a height of the second protrusion 232, and the height direction is parallel to the first direction. The first stop face 27 is adjacent to a side of the second protrusion 232.

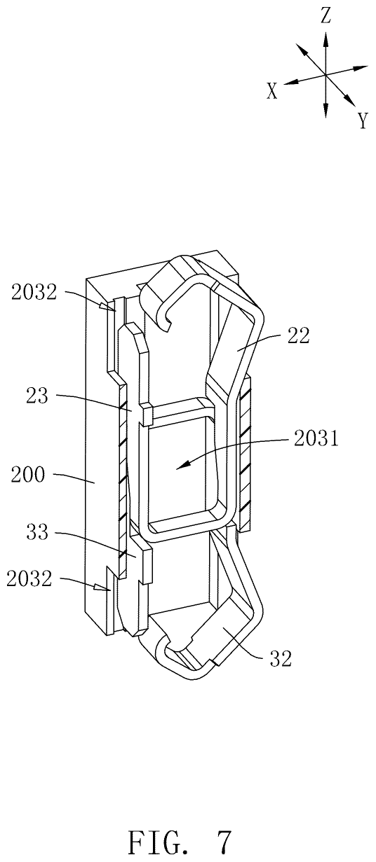

Referring to FIG. 7, the insulating body 200 has two fixing grooves 2032 internally, which are respectively formed on the two side walls of the terminal slot 203. The first protrusion 231 and the second protrusion 232 can be inserted into and fixed in the two fixing grooves 2032.

Understandably, the fixing grooves 2032, by engaging the first protrusion 231 and the second protrusion 232, restrict the first conductive member 20 along the second direction and the width direction, so that the first conductive member 20 can be stably arranged in the insulating body 200.

In some embodiments, the second extension portion 34 extends along the first direction and is formed by extending upward from the second fixing portion 33. The second fixing portion 33 connects to a second fixing section 312, and the second extension portion 34 provides contact for the second inward-bending section 323. The second fixing portion 33 and the second resilient arm portion 32 each has a downward-facing second stop face 37, located beside the second connecting portion 31. The first connecting portion 21 is blocked above the second stop face 37.

In some embodiments, the width of the second fixing portion 33 is greater than the width of the second extension portion 34, and the width of the second connecting portion 31 is less than the width of the second extension portion 34, so that the second fixing portion 33 can be inserted and fixed in the fixing groove 2032.

In some embodiments, the second fixing portion 33 includes a first protrusion 331 and a second protrusion 332 arranged on two sides thereon. A height of the first protrusion 331 is less than a height of the second protrusion 332, and the height direction is parallel to the first direction. The second stop face 37 is adjacent to a side of the second protrusion 332.

Understandably, the fixing grooves 2032, by engaging the first protrusion 331 and the second protrusion 332, restrict the second conductive member 30 along the second direction and the width direction, so that the second conductive member 30 can be stably arranged in the insulating body 200. At the same time, the first conductive member 20 and the second conductive member 30 restrict each other along the first direction to achieve restriction and fixture in all directions.

In some embodiments, the first conductive member 20 and the second conductive member 30 have the same structure. For example, the first conductive member 20 and the second conductive member 30 are symmetrically arranged, and the line of symmetry is located on a straight line parallel to the second direction and passing through the geometric center of the terminal 100 (i.e., the dashed line L in FIG. 5). Thus, the terminal 100 has two conductive clips having identical structures arranged oppositely and combined. The first conductive member 20 and the second conductive member 30 can adopt the same structure, simplifying the manufacturing process of a single conductive member 10 and reducing manufacturing costs.

Finally, it should be noted that the above embodiments are only used to illustrate the technical solutions of the present disclosure and are not intended to limit the same. Although the present disclosure has been described in detail with reference to preferred embodiments, those skilled in the art should understand that modifications or equivalent substitutions can be made to the technical solutions of the present disclosure without departing from the spirit and scope of the technical solutions of the present disclosure.

1. An electrical connector comprising:
an insulating body; and
at least one terminal being fixed to the insulating body and having a first conductive member and a second conductive member independent of each other; wherein
the first conductive member has a first connecting portion, a first resilient arm portion, and a first fixing portion, the first resilient arm portion and the first fixing portion are respectively connected to two ends of the first connecting portion;
the second conductive member has a second connecting portion, a second resilient arm portion, and a second fixing portion, the second resilient arm portion and the second fixing portion are respectively connected to two ends of the second connecting portion; and
a width of the first connecting portion is smaller than a width of the first fixing portion and is offset to form a first accommodating space below the first fixing portion, a width of the second connecting portion is smaller than a width of the second fixing portion and is offset to form a second accommodating space above the second fixing portion, the first connecting portion is positioned in the second accommodating space, and the second connecting portion is positioned in the first accommodating space.

2. The electrical connector according to claim 1, wherein the first connecting portion has a first inclined face facing the first accommodating space, the second connecting portion has a second inclined face facing the second accommodating space, and the first inclined face and the second inclined face abut each other.

3. The electrical connector according to claim 2, wherein the first fixing portion and the first resilient arm portion each have a downward-facing first stop face, each of the first stop faces is positioned beside the first connecting portion, the second fixing portion and the second resilient arm portion each have an upward-facing second stop face, each of the second stop faces is positioned beside the second connecting portion, the first connecting portion is positioned above the second stop faces, and the second connecting portion is positioned below the first stop faces.

4. The electrical connector according to claim 3, wherein the first fixing portion and the second fixing portion respectively include a first protrusion and a second protrusion arranged on two sides thereof, a height of the first protrusion is less than a height of the second protrusion, and one of the first stop faces and one of the second stop faces are respectively positioned proximal to the second protrusions.

5. The electrical connector according to claim 1, wherein the insulating body has an accommodating slot and a fixing groove, the first fixing portion and the second fixing portion are fixed in the fixing groove, and the first resilient arm portion, the second resilient arm portions, the first connecting portion and the second connecting portions are accommodated in the accommodating slot.

6. The electrical connector according to claim 1, wherein:
the first conductive member has a first extension portion extending upward from the first fixing portion, the first resilient arm portion is bent towards the first extension portion, and when the first resilient arm portion is compressed and moved downward, the end of the first resilient arm portion abuts the first extension portion; and
the second conductive member has a second extension portion extending downward from the second fixing portion, the second resilient arm portion is bent towards the second extension portion, and when the second resilient arm portion is compressed and moved upward, the end of the second resilient arm portion abuts the second extension portion.

7. The electrical connector according to claim 6, wherein the width of the first fixing portion is greater than a width of the first extension portion, the width of the first connecting portion is less than the width of the first extension portion, the width of the second fixing portion is greater than a width of the first extension portion, and the width of the second connecting portion is less than the width of the second extension portion.

8. The electrical connector according to claim 6, wherein the first connecting portion and the second connecting portion are each U-shaped and each include two vertical portions and a horizontal portion connecting the two vertical portions, the vertical portion of the first conductive member has the first inclined face, and the vertical portion of the second conductive member has the second inclined face.

9. The electrical connector according to claim 1, wherein the first conductive member and the second conductive member have the same structure, the first conductive member is inserted through an upper face of the insulating body, and the second conductive member is inserted through a lower face of the insulating body.
